(19) United States
(12) Patent Application Publication
(10) Pub. No.: US 2014/0278598 A1
(43) Pub. Date: Sep. 18, 2014

(54) CACHING RESERVATION OPTIONS

(71) Applicant: ACCENTURE GLOBAL SERVICES LIMITED, Dublin (IE)

(72) Inventor: Michael A. Padgen, Salt Lake City, UT (US)

(73) Assignee: ACCENTURE GLOBAL SERVICES LIMITED, Dublin (IE)

(21) Appl. No.: 13/840,412

(22) Filed: Mar. 15, 2013

(51) Int. Cl. G06Q 10/02

(52) U.S. Cl. CPC G06Q 10/02
USPC 705/5

(57) ABSTRACT

Caching travel options, in which a first request is received for lowest available fare data and, responsive to the first request, a determination is made that data for the lowest available fare is not included in a cache. Based on the determination, a request is provided to a core system for the data and the data for the lowest available fare is received from the core system. The received data is stored in the cache and used to respond to the first request. After storing, in the cache, the received data, a second request is received for the lowest available fare. Responsive to the second request, a determination is made that the data for the lowest available fare is included in the cache and, based on that determination, the data is accessed from the cache and used to respond to the second request.

### TECHNICAL FIELD

This specification generally describes systems and processes for caching travel options.

### BACKGROUND

Online reservation systems can be used to make travel reservations. Since travelers have become more cost sensitive, they are looking for ways to reduce their travel costs. Many travelers are willing to be more flexible about their travel dates in order to obtain low cost accommodations. To promote flexibility, online reservation systems calculate the lowest cost available for a travel option across a wide range of travel dates so the traveler can then select a low cost available option.

### SUMMARY

In general, innovative aspects of the subject matter described in this specification may be included in methods that include actions of receiving a first request for lowest available fare data including a lowest available fare for a particular travel route for a specific date and, responsive to the first request, determining that data for the lowest available fare for the particular travel route for the specific date is not included in a cache. The actions also include, based on determining that the data for the lowest available fare for the particular travel route for the specific date is not included in the cache, providing, to a core system, a request for the data for the lowest available fare for the particular travel route for the specific date and receiving, from the core system, the data for the lowest available fare for the particular travel route for the specific date. The actions further include storing, in the cache, the received data for the lowest available fare for the particular travel route for the specific date and responding to the first request based on the data received from the core system for the lowest available fare for the particular travel route for the specific date. In addition, the actions include, after storing, in the cache, the received data for the lowest available fare for the particular travel route for the specific date, receiving a second request for lowest available fare data including the lowest available fare for the particular travel route for the specific date and, responsive to the second request, determining that the data for the lowest available fare for the particular travel route for the specific date is included in the cache. The actions also include, based on determining that the data for the lowest available fare for the particular travel route for the specific date is included in the cache, accessing, from the cache, the data for the lowest available fare for the particular travel route for the specific date and responding to the second request based on the data accessed from the cache for the lowest available fare for the particular travel route for the specific date.

Other implementations of these aspects include corresponding systems, apparatus, and computer programs, configured to perform the actions of the methods, encoded on computer storage devices.

These and other implementations may each optionally include one or more of the following features. For example, the travel route may be comprised of one or more segments and the actions may include accessing a queue and determining that the queue includes an entry associated with a segment of the particular travel route for the specific date. In this example, the actions may include determining that the entry impacts reliability of the data for the lowest available fare for the particular travel route for the specific date and, based on determining that the entry impacts reliability of the data for the lowest available fare for the particular travel route for the specific date, deleting, from the cache, the data for the lowest available fare for the particular travel route for the specific date.

In addition, the actions may include determining that travel accommodations in a fare class for the segment of the particular travel route are no longer available. The actions also may include determining that a specified time frame for availability of the segment of the particular travel route has expired. The actions further may include determining that travel accommodations for the segment of the particular travel route are not available.

In some implementations, the actions may include storing an entry in the queue based on a change in inventory for a travel conveyance providing accommodations for one or more components of a travel route. The actions also may include storing an entry in the queue based on a change in the available fare for one or more segments of a travel route. The actions further may include storing an entry in the queue based on determining that a change in commitment affects the availability of a fare for one or more segments of a travel route.

In some examples, the actions may include deleting, from the cache, one or more entries based on one or more rules for deleting a cache entry. In these examples, the one or more rules include a rule that specifies deleting cache entries based on a time frame.

In some implementations, the actions may include receiving an additional request for a lowest available fare for the particular travel route for one or more dates other than the specific date and, responsive to receiving the additional request, determining, for each of the one or more dates, whether data for the lowest available fare for the particular travel route is included in the cache;. In these implementations, the actions may include providing, to a core system, a request for the data for the lowest available fare for the particular travel route for each of the one or more dates whose data for the lowest available fare for the particular travel route is not included in the cache and receiving, from the core system, the data for the lowest available fare for the particular travel route for each of the one or more dates whose data for the lowest available fare for the particular travel route is not included in the cache. Further, in these implementations, the actions may include storing, in the cache, the received data for the lowest available fare for the particular travel route for each of the one or more dates and responding to the additional request based on the data accessed from the cache for the lowest available fare for the particular travel route for each of the one or more dates other than the specific date. The one or more dates other than the specified date may be during a certain time period relative to the specific date.

In some examples, an availability service may receive the first request for a lowest available fare data for a particular travel route for a specific date, determine that the lowest available fare for the particular travel route for the specific date is not included in a cache, and interface with the core system to request and receive the data for the lowest available fare for the particular travel route for the specific date. In these examples, the availability service may be one of a plurality of availability services, and a selection of an availability service to receive the first request is based on one or more load factors associated with each of the plurality of availability services.

In addition, the actions may include storing an indication that the data for the lowest available fare for the particular travel route for the specific date was not included in the cache. The actions also may include responding to the second request based on the data accessed from the cache for the lowest available fare for the particular travel route for the specific date comprises responding with no interaction with the core system.

In some implementations, the data for the lowest available fare for the particular travel route for the specific date stored in the cache may be different from the data for the lowest available fare for the particular travel route for the specific date when booking a travel accommodation for the particular travel route for the specific date. In these implementations, the actions may include recording occurrences of the lowest available fare for the particular travel route for the specific date stored in the cache being different from the lowest available fare for the particular travel route for the specific date when booking a travel accommodation for the particular travel route for the specific date.

The details of one or more implementations of the subject matter described in this specification are set forth in the accompanying drawings, and the description, below. Other features, aspects and advantages of the subject matter will be apparent from the description and drawings, and from the claims.

### BRIEF DESCRIPTION OF DRAWINGS

FIG. 1 is a block diagram illustrating an example system that can execute implementations of the present disclosure.

FIG. 2 is an example of a view for a low fare schedule for a travel route.

FIG. 3 is a block diagram illustrating example components of a low fare availability system that utilizes a distributed in-memory low fare cache.

FIG. 4 is a block diagram illustrating components of a low fare availability system that utilizes a centralized database-backed low fare cache.

FIGS. 5A-C are block diagrams that show example data structures.

FIGS. 6A-B are block diagrams showing an example low fare cache database.

FIG. 7 depicts an example process for determining an available low fare for a travel route for a specific date.

FIG. 8 depicts an example process for receiving booking change events for storage in a queue.

FIG. 9 depicts an example process for reading a queue to determine if a queue entry invalidates a cache entry.

### DETAILED DESCRIPTION

In the following text, a detailed description of examples will be given with reference to the drawings. Various modifications to the examples may be made. In particular, elements of one example may be combined and used in other examples to form new examples, which fall within the scope of the present disclosure.

For purposes of illustration, a non-limiting example context is provided herein. The example context is directed to the cost of a travel accommodation including a seat on a travel conveyance. In some examples, a travel conveyance can include an airplane, a train, a bus and a ship (e.g., a cruise ship). Although implementations of the present disclosure are discussed in the example context of fares for seats on a travel conveyance, the present disclosure is applicable in other contexts. In some examples, a travel accommodation can include a room on a travel conveyance (e.g., a room on a cruise ship).

Within the example context of finding a lowest fare for an accommodation on a travel conveyance, a traveler wishes to determine the availability of low cost travel fares for a specific travel route (e.g., Minneapolis to Boston). The traveler has a flexible travel schedule and is interested in determining the availability of the lowest fares for the specific travel route over a wide range of travel dates (e.g., over a full calendar month for the month of June 2013). In some cases, a low fare availability system may obtain fares for the specific travel route over the wide range of travel dates from multiple travel conveyance providers. In other cases, the low fare availability system may obtain fares for the specific travel route over the wide range of travel dates from a global distribution system. The acquiring of this data can place extra load constraints on the travel conveyance providers and the global distribution systems. The low fare availability system processes the obtained travel fare data for each requested travel date for the specific travel route in order to calculate the lowest available fares. The time to gather the travel fare data and to calculate the lowest available fares for the range of travel dates can affect the performance of the low fare availability system, slowing down the response from the service to the traveler's request. In order to improve the traveler's experience with the service, the provider of the low fare availability system may need to include additional computing power resulting in increased system costs. In addition or in the alternative, the provider of the low fare availability system may need to purchase additional software support for the service in order to improve its performance. In some implementations, a low fare availability system can access current and reliable available low fare data for a variety of travel routes over a multitude of travel dates from a cache. The low fare availability system can load low fare data for requested travel dates and travel routes into the cache when a first request is made for the data. The low fare availability system can provide subsequent requests for the data from the cache, significantly reducing the processing time needed to calculate the data and eliminating the need to obtain the data from other systems. The low fare availability system can invalidate a cache entry when the service determines that the stored data for a travel date and route is no longer the currently available lowest fare. The low fare availability system can also store in the cache a set of parameters associated with each low fare data entry stored in the cache, where the parameters can affect how the data may be applied to the determination of a lowest fare.

As the cost of travel increases, many travelers are becoming more flexible about their travel dates in order to reduce their travel costs. In order to make an informed decision, the traveler can request a single view of fare data over a wide range of dates in order to compare costs. In order to provide the low fare data quickly and reliably to the customer for the multitude of dates, systems need to accommodate for increased load factors and computing costs associated with generating the low fare data for each date when it is requested. Pre-calculating and storing much of low fare data in an in-memory cache can reduce the time and overhead needed to generate the costs each time they are requested, and can speed up the access time for retrieving the low fare data when it is requested. The use of a low fare cache can improve a customer's interaction with a system that provides low fare data over the wide range of travel dates.

FIG. 1 depicts an example system 100 that can execute implementations of the present disclosure. The example system 100 includes a computing device 102 with a display 102a, a computing system 104 and a network 106. The computing device 102 and the computing system 104 can communicate over the network 106. A user 108 can operate the computing device 102. The computing system 104 can include one or more computing devices 110 and one or more computer-readable storage devices 112. Another computing device 116 with a display 116a can be provided and can be operated by a user 118.

In some implementations, the computing devices 102, 116 can be computing devices such as laptop or desktop computers, smartphones, personal digital assistants, portable media players, tablet computers, or other appropriate computing devices that can be used to communicate with an electronic network. In some implementations, the computing devices 102, 116 perform client-side operations, as discussed in further detail herein. In some implementations, the computing system 104 can include one or more computing devices such as a computer server. In some implementations, the computing system 104 can represent more than one computing device working together to perform the server-side operations, as discussed in further detail herein. In some implementations, the network 106 can be a public communication network (e.g., the Internet, cellular data network, dialup modems over a telephone network) or a private communications network (e.g., private LAN, leased lines).

In some implementations, the example system 100 can be used to determine available lowest fares for a travel conveyance 120. In some examples, the computing system 104 hosts a low fare availability system that includes a low fare availability service that provides low fare data for the travel conveyance 120 from a cache.

In some implementations, the example system 100 can be used to determine and provide available lowest fares for a specific travel route over a specified range of travel dates. For example, the user 108 can be a traveler and can access a low fare availability interface provided on the computing device 102. In some implementations, a low fare availability system can be provided as part of a web-based system that provides a low fare availability interface within a general purpose browser executed on the computing device 102. The user 108 can view information regarding the lowest available fares for the specific travel route over the specified range of travel dates.

FIG. 2 is an example of a view 200 for a low fare schedule for a travel route 202. Referring to FIG. 1, for example, a display 102a of the computing device 102 can display the view 200 to the user 108. In this example, as shown by the indicator 202, the user wishes to travel by plane from Minneapolis to Boston sometime during June 2013. A low fare availability interface running on the computing device 102 can display the requested full calendar view of lowest fares. The user 108 can select an available lowest fare, for example, by clicking a pointing device while hovering an indicator corresponding to the pointing device over a displayed low fare on a particular day included in the full calendar view displayed in the web page. For example, clicking on an indicator 204 for the lowest fare on June 27^{th} navigates the user to a web resource where the user can proceed to book travel on Jun. 27, 2013 on a travel conveyance at the available lowest fare.

Referring to FIG. 1, in some examples, the user 118 can be an agent and can access a low fare availability interface provided on the computing device 116. In some examples, the agent can be an independent agent (e.g., a travel agent). In some implementations, a low fare availability system can be part of a web-based system that provides a low fare availability interface within a general purpose browser or a specific browser executed on the computing device 116. The user 118 can request and view available low fares for a travel route for a range of travel dates. For example, a travel agent can interface with view 200 displayed on a display 116a of the computing device 116 to select a lowest fare for a traveler (e.g., click on indicator 206) and proceed with a booking for the traveler at the lowest fare.

In some cases, the travel route can be made up of one or more segments. In some examples, the travel route for an airplane can include a single segment (e.g., a flight departing from a first airport and arriving at a second airport). In some examples, the travel route for an airplane can include multiple segments (e.g., a first flight departing from a first airport and arriving at a second airport, and a second flight departing the second airport and arriving at a third airport). The sum of the fares for each segment is the total fare for the travel route. Therefore, the total fare for a multiple segment travel route is based on the fare for each segment.

FIG. 3 illustrates example components of a low fare availability system 300 that utilizes a distributed in-memory low fare cache. For purposes of illustration, a non-limiting example context is provided that is directed to a travel accommodation including a seat on a travel conveyance (e.g., an airplane).

The system 300 interfaces with a core travel booking and reservation system and provides low fare availability functionality to the core system. The system 300 can generate data for available low fares for a specific date or range of dates for a plurality of travel segments. The system 300 may be separate from the core system or may be part of the core system.

The core system can provide one or more availability services 302, 304 with booking information and other core functions the availability services 302, 304 can use to provide fare data for available accommodations on a travel conveyance. The core system can gather fare data for a travel route from multiple travel accommodation providers for one or more travel dates and, using the fare data, can calculate the lowest available fare for the travel route on a travel date. Included with the low fare data are one or more dependencies that impact the low fare data. The one or more dependencies can be expressed as one or more parameters associated with the low fare. The core system provides the low fare data to one or more availability services (e.g., availability service 302, 304). The number of availability services needed in the system 300 may be modified based on loading factors in order to provide an optimum system load.

Each availability service 302, 304 includes a low fare availability service module 302a, 304a, respectively. The availability services 302, 304 can use the low fare availability service module 302a, 304a to manage an in-memory low fare cache 302b, 304b, an availability service (AS) listener 302c, 304c, and a low fare database 302d, 304d, respectively. The functionality of the availability service 302 and its components is described in more detail below. The description also applies to the availability service 304, and any other availability services provided by the core system.

The availability service 302 stores low fare data provided by the core system in the low fare cache 302b. As such, the low fare cache 302b stores calculated low fare data that can be later accessed by the availability service 302, without the need for further calculations. In addition, the availability service 302 can store the low fare data in a low fare database 302d as a backup to the low fare cache 302b.

When a request for low fare data is received, the system 300 identifies an availability service that can service the request. The request may be received from a third party system that aggregates and presents low fare data from multiple, different travel providers. In some cases, the system 300 uses a load balancer to identify the availability service with the most capacity at the time the request is received. In other cases, the core system uses a round robin technique that rotates through the availability services to identify the availability service that will service the request.

The system 300 includes a low fare queue 306 that can store data associated with changes in a travel conveyance reservation system. For example, the changes can include, but are not limited to: fare changes (e.g., a change in a fare for a travel segment on one or more dates), inventory changes (e.g., additional seats are made available on an airplane based on an equipment swap opening up a fare class), and commitment changes (e.g., a passenger cancels their reservation making an accommodation in a particular class of service available where the fare for that class of service was unavailable because the class of service previously had no available accommodations, a passenger books the last available accommodation in a particular class of service making the fare for that class unavailable, etc.).

The system 300 includes a fare availability status (AVS) sink 308 and an inventory AVS sink 310. In the example of FIG. 3, a sink is a configurable component included in the core system that receives information provided by the core system. Each of the sinks 308, 310 interfaces with the low fare queue 306. For example, each of the sinks 308, 310 can receive travel conveyance reservation changes specific to the function of each sink and can provide that information to the low fare queue 306 for storage in the low fare queue. For example, the sinks 308, 310 can provide the respective reservation change information to the low fare queue 306 in the form of a message. The fare AVS sink 308 can send a fare change message about a fare change for a travel segment on one or more dates to the low fare queue 306. The message can indicate a booking class change causing a fare class to become unavailable. The inventory AVS sink 310 can send, to the low fare queue 306, an inventory change message about a change in the number of seats available at a particular fare for a travel segment on one or more dates. The message can indicate the addition of inventory or the cancellation of inventory for a travel segment on one or more dates.

The system 300 also includes a commit AVS sink 312. The commit AVS sink 312 receives travel conveyance reservation changes that result in commitment or booking changes (e.g., assignment of seats, cancellation of seat assignments, etc.). In the system 300, the commit AVS sink 312 interfaces with an AVS queue 314 and provides the AVS queue 314 the commitment change information in the form of a message.

A low fare cache monitor 316 includes a low fare (LF) listener 318. The low fare cache monitor 316 can implement the LF listener 318 as a separate process running in the low fare cache monitor 318 that monitors the messages stored in the AVS queue 314. The LF listener 318 can filter out messages prior to storage in the low fare queue 306. The LF listener 318 can determine whether a message stored in the AVS queue 314 affects the availability of a fare (e.g., a booking class status changes). For example, a message indicates that the last seat in a specific fare class of seats in a travel conveyance for a travel segment on a particular date was booked. The LF listener 318 reads the message in the AVS queue 314, and determines that the commitment change results in the fare class no longer being available (the fare class is closed) and that the message should be sent to the low fare queue 306 for storage in the queue 306. In another example, the LF listener 318 determines that the commitment change does not close the fare class (there are additional seats available in the fare class in the travel conveyance for the travel segment on the particular date), and, therefore, the message should not be sent to the low fare queue 306.

In some implementations, the LF listener 318 filters out any commitment changes that would not impact the availability or price of a fare computed by the core system. In these implementations, the LF listener 318 determines whether a commitment change in the AVS queue 314 is a type of commitment change that may impact the availability or price of a fare. Based on a determination that the type of the commitment change may have an impact on the availability or price of a fare (e.g., a booking or a cancellation), the LF listener 318 does not filter the commitment change and provides the commitment change to the low fare queue 306. Based on a determination that the type of the commitment change would not have an impact on the availability or price of a fare (e.g., a seat assignment change), the LF listener 318 filters the commitment change and deletes the commitment change without providing the commitment change to the low fare queue 306.

The availability service 302 can implement the AS listener 302c as a separate process running in the availability service 302 that monitors the messages stored in the low fare queue 306. The AS listener 302c can read the messages in the low fare queue 306 and can determine whether the contents of a message impacts the reliability of one or more entries in the in-memory low fare cache 302b. If the contents of the message impacts the reliability of one or more entries in the low fare cache 302b, the LF availability service 302a can invalidate the entries in low fare cache 302b (e.g., flag each impacted entry as invalid).

In some implementations, the low fare availability service 302a can delete the invalidated one or more entries from the low fare cache 302b. In some examples, the low fare availability service 302a can delete an entry from the low fare cache 302b based on the value of one or more parameters associated with the entry. For instance, a parameter can indicate the entry is valid up to a certain date and time. If the availability service 302 determines that the current date and time are later than the date and time indicated in the parameter for the low fare cache entry, the low fare availability service 302a can invalidate or delete the entry.

In some implementations, the low fare availability service 302a can delete all cache entries at a regular time interval. For example, at 12:00 am each day, the low fare availability service 302a can clear the low fare cache 302b.

In some implementations, the availability service 302 can reload an entry into the low fare cache 302b when the AV listener 302c invalidates the entry based on the contents of a message read by the AV listener 302c from the low fare queue 306. For example, the availability service 302 can request low fare data from the core system using the parameters associated with the current low fare data entry in the cache and, once the low fare data is received, the availability service 302 can overwrite the entry in the low fare cache 302b with the updated low fare data received from the core system.

The process selected for deleting entries in the low fare cache 302b may be determined based on performance parameters associated with the system 300. In some implementations, the system 300 can track the number of times the requested low fare data was found in the cache and the number of times the availability service 302 requested the low fare data from the core system. In some implementations, the core system can track “bookability” by logging the occurrence of the number of instances of a user booking an available low fare as provided to them by the system 300. In some cases, when a user attempts to book the low fare (e.g., the user clicks on an indicator for the lowest fare as shown in FIG. 2) by navigating to a booking web page for a travel conveyance provider, the low fare is no longer available or the travel conveyance provider is no longer honoring the low fare. The logged data can be analyzed to determine the ongoing validity of the low fare data stored in the low fare cache 302b and provided by the system 300. For example, the validity of certain low fare data stored in the low fare cache 302b may be associated with a particular travel segment (e.g., identified low fares provided by the low fare cache 302b for travel segments from Los Angeles to Phoenix have a percentage of unavailability in a reservation booking system that is above a predetermined acceptable threshold).

When the availability service 302 receives a request for a lowest fare for a travel route for a specific date, the availability service 302 first accesses the in-memory low fare cache 302b for low fare data that matches the received request. If the low fare data that matches the received request is not available in the low fare cache 302b, the availability service 302 requests the low fare data from the core system. The core system can gather fare data for the travel route for the specific date and calculate the lowest available fare. The availability service 302 receives the low fare data and stores the low fare data in the low fare cache 302b, and provides the low fare data in a response to the received request.

Each availability service 302, 304 in the system 300 implements an in-memory low fare cache (low fares caches 302b, 304b, respectively). The low fare data stored in each of the low fare caches 302b, 304b can be dependent on the low fare data requests received by each availability service 302, 304, making the low fare data stored in the low fare caches 302b, 304b different in each cache and unique to each availability service 302, 304. The low fare data stored in each of the low fare caches 302b, 304b can be also be dependent on how often each listener 302c, 304c accesses the low fare queue 306.

In some implementations, each listener 302c, 304c accesses the low fare queue 306 at the same time to retrieve the next message available in the low fare queue 306. In this regard, the low fare queue 306 represents a common log accessible to each listener 302c, 304c. The listeners 302c, 304c can be configured to read messages in the low fare queue 306 from a point in time at which the availability service 302, 304 of the corresponding listener is instantiated. Because the system 300 is scalable, availability services may be, over time, instantiated or deleted as needed depending on the load on the system 300. When an availability service is instantiated, the listener of that availability service begins reading from the low fare queue from that point forward, until the availability service is deleted. This can provide a type of management that supports the distributed in-memory low fare cache configuration shown in FIG. 3.

FIG. 4 illustrates example components of a low fare availability system 400 that utilizes a centralized database-backed low fare cache. The system 400 includes availability services 402, 404. Referring to FIG. 3, the availability services 402, 404 perform in a similar manner to the availability services 302, 304, respectively. In the system 400, availability services 402, 404 include low fare availability services 402a, 404a that perform in a similar manner as the low fare availability services 302a, 304a, respectively.

The system 400 includes a fare AVS sink 408, an inventory AVS sink 410, and a commit AVS sink 412 that perform in a similar manner as the fare AVS sink 308, the inventory AVS sink 310, and commit AVS sink 312, respectively. An AVS queue 414 and a low fare queue 406 perform in a similar manner as the AVS queue 314 and a low fare queue 306, respectively.

A low fare cache monitor 416 includes a low fare (LF) listener 418 and an availability service (AS) listener 422. In the system 400, the low fare cache monitor 416 performs in a manner similar to the low fare cache monitor 316. The low fare cache monitor 416 can implement the LF listener 418 as a separate process running in the low fare cache monitor 416 that monitors the messages stored in the AVS queue 414. The monitoring and filtering of messages stored in the AVS queue 414, by the LF listener 418, is performed in a similar manner as the monitoring and filtering of messages stored in the AVS queue 314, by the LF listener 318.

The low fare cache monitor 416 can implement the AS listener 422 as a separate process running in the low fare cache monitor 416 that monitors the messages stored in the low fare queue 406. The low fare cache monitor 416 can perform centralized monitoring of the low fare queue 406 for the system 400. The AS listener 422 can read the messages in the low fare queue 406 and can determine whether the contents of a message impacts the reliability of one or more entries in the SQL low fare cache 416a. The SQL low fare cache 416a is a virtual cache that does not actually store low fare data, but interacts with the AS listener 422 in a manner similar to how the listeners 302c, 304c interact with the low fares caches 302b, 304b in FIG. 3. For instance, if the content of the message impacts the reliability of one or more entries, the AS listener 422 sends a command to the low fare cache 416a to invalidate the one or more entries. Instead of modifying stored data to reflect the invalidation, as done by the low fares caches 302b, 304b in FIG. 3, the low fare cache 416a translates the command to invalidate the one or more entries into database commands that invalidate the one or more entries in the centralized database 420. The low fare cache 416a provides the database commands to the SQL data access (DAL) interface 416b that executes the database commands on the centralized database 420 to invalidate the one or more entries in the centralized database 420.

Each availability service 402, 404 includes a structured query language (SQL) low fare cache 402b, 404b, respectively. The use of the SQL low fare caches 402b, 404b provides a virtual cache implementation in each availability service 402, 404 that appears as a cache, but that utilizes the centralized low fare database 420 to store and retrieve low fare data. In addition, the low fare cache monitor 416 includes an SQL low fare cache 416a that also utilizes the centralized low fare database 420. Each availability service 402, 404 as well as the low fare cache monitor 416 use an SQL data access (DAL) interface 416b, 402c, 404c to allow each SQL low fare cache 416a, 402b, 404b, respectively, access to the centralized low fare database 420. The SQL DAL interfaces 416b, 402c, 404c allow read and write access between each respective SQL low fare cache 416a, 402c, 404c, and the centralized low fare database 420.

The system 400 can also interface with a core travel booking and reservation system that calculates low fare data and provides the calculated low fare data to the system 400. The system 400 can generate data for available low fares for a specific date or range of dates for a plurality of travel segments. When the availability service 402 receives a request for a lowest fare for a travel route for a specific date, the availability service 402 first accesses the SQL low fare cache 402b for low fare data that matches the received request. If the low fare data that matches the received request is not available in the low fare cache 302b, the availability service 302 requests the low fare data from the core system. The core system can gather fare data for the travel route for the specific date and calculate the lowest available fare. The availability service 402 receives the low fare data and provides the low fare data to the SQL low fare cache 402b and provides the low fare data in a response to the received request. In addition, the SQL low fare cache 402b can write the received low fare data into the centralized low fare database 420 using SQL DAL 402c.

The use of the centralized low fare database 420 allows the availability service 404 to cache the low fare data stored in the centralized low fare database 420 by availability service 402. The availability service 404 can read the data from the low fare database 420 into the SQL low fare cache 404b using SQL DAL 404c. In the example of FIG. 4, the availability services 402, 404 can effectively share low fare data by reading the contents of the low fare database 420 and storing new low fare data in the low fare database 420 using the respective SQL low fare cache 402b, 404b and the respective SQL DAL 402c, 404c.

The use of a centralized low fare database 420 can provide data sharing and synchronization between availability services 402, 404 and the low fare cache monitor 416. Implementing the listeners (e.g., LF listener 418 and AS listener 422) in the low fare cache monitor 416 allows for the use of a single source to determine whether the contents of a message in the low fare queue 406 impacts the reliability of one or more entries in the low fare database 420. If the content of the message impacts the reliability of one or more entries, the low fare cache monitor 416 can invalidate the one or more entries in the low fare database 420 using the SQL low fare cache 416a and the SQL DAL 416b.

FIG. 5A shows example data structures 502, 504, 506 for low fare data provided by a core system to an availability service. Each data structure 502, 504, 506 includes one or more parameters that are associated with low fare data stored in the cache. The data structures 502, 504, 506 may be used to store the low fare data in the in-memory low fare cache (e.g., in-memory low fare cache 302b as shown in FIG. 3), where the parameters can affect how the low fare data may be applied to the determination of a lowest fare. In the example shown in FIG. 5, the data structures 502, 504, 506 are associated with a flight in a particular market (or travel route).

A DateMarketLowFare structure 502 stores the low fare data for a specified date and travel route or market. The data stored in the DateMarketLowFare structure 502 is used to respond to low fare requests and represents the low fare data ultimately displayed to a user. The parameters in the DateMarketLowFare structure 502 include, but are not limited to: an arrival city parameter 502a that specifies an arrival station for the market; a carrier code parameter 502b that specifies a code for the travel conveyance; a departure city parameter 502c that specifies a departure station for the market; a departure date parameter 502d that specifies a date of departure for flights in the market; an expire Coordinated Universal Time (UTC) parameter 502e that specifies a date and time in UTC when the fare expires (is no longer valid); a fare amount parameter 502f that specifies a total discounted fare with surcharges (e.g., the fare amount includes “included” taxes and travel fees, but not “additional” taxes and travel fees); an includes taxes and fees parameter 502g that indicates “additional” taxes and travel fees were calculated; a taxes and fees amount parameter 502i that specifies a total “additional” tax and travel fees; and a status code 502h that indicates the status of the low fare for the date and market (e.g., valid indicates the low fare returned is available for this date and market, invalid indicates fare returned is not reliable or valid for this date and market, and not available indicates there are no available flights or fares for this date and market). The DateFlightLowFare structure 504 stores data representative of individual flights that are part of the DateMarketLowFare structure 502.

A DateMarketSegment structure 506 includes parameters that identify a segment and/or leg dependency for a DateMarketLowFare structure 502. The DateMarketSegment structure 506 stores data related to dependencies that impact the reliability of data stored in the DateMarketLowFare structure 502. The DateMarketSegment structure 506 is used to manage the cache and does not represent data that is displayed to a user. The parameters in the DateMarketSegment structure 506 include, but are not limited to: an arrival city parameter 506a that specifies the arrival city for the segment and/or leg; a carrier code parameter 506b that specifies a code for the travel conveyance; a date market segment type parameter 506c that indicates the type of date market segment (e.g., a segment, a leg, or both a segment and a leg); a departure city parameter 506d that specifies a departure city for the segment and/or leg; and a departure date parameter 506e that indicates the date of departure for the segment and/or leg.

FIG. 5B shows example data structures 520, 522, 524 used for requests for low fare data. The example data structures 520, 522, 524 may specify the format of a request needed to successfully communicate with and receive low fare data from an application programming interface (API) operated by any one of the systems described throughout this disclosure. The LowFareTripAvailabilityRequest structure 520 defines a structure of a request for low fare data related to an entire trip. The LowFareTripAvailabilityRequest structure 520 may include one or more LowFareAvailabilityRequest structures 522 that define a particular low fare that is part of the entire trip. The AlternateLowFareRequest structure 524 defines parameters for requesting alternate low fare pricing for each date, market, and flight, if applicable.

FIG. 5C shows example data structures 530, 532, 534, 536, and 538 for low fare data provided by a core system to an availability service. Each data structure 530, 532, 534, 536, and 538 includes one or more parameters that are associated with low fare data stored in the cache. The data structures 530, 532, 534, 536, and 538 may be used to store the low fare data in the in-memory low fare cache (e.g., in-memory low fare cache 302b as shown in FIG. 3). The data structures 530, 532, 534, 536, and 538 may store data used in responding to requests formatted using the data structures shown in FIG. 5B.

The data stored in the DateMarketLowFare structure 530 is used to respond to low fare requests and represents the low fare data ultimately displayed to a user. The DateFlightLowFare structure 532 stores data representative of individual flights that are part of the DateMarketLowFare structure 530. The DateFlightLeg structure 534 stores data representative of individual flight legs that are part of the individual flights stored in the DateFlightLowFare structure 532. The AlternateLowFare structure 536 stores alternate low fare pricing for each date and market. The DateMarketSegment structure 538 stores data related to dependencies that impact the reliability of data stored in the DateMarketLowFare structure 530. The DateMarketSegment structure 538 is used to manage the cache and does not represent data that is displayed to a user.

FIGS. 6A-B show an example low fare cache database representation 600. In the example low fare cache database 600, a ParameterSet database table 602 stores normalized available low fare parameter data. A DateMarket database table 604 stores normalized date markets. A DateMarketLowFare database table 606 stores low fare amounts for each date, market, and parameter set. The DateMarketLowFare database table 606 is a child of the DateMarket database table 604 with an identifying relationship and a one-to-many cardinality. Whenever a row is inserted into the DateMarket database table 604, one or more DateMarketLowFare database tables will also be inserted. A DateMarketSegment database table 608 stores date and market segment dependencies. The DateMarketSegment database table 608 is a child of the DateMarket database table 604 with an identifying relationship and a one-to-many cardinality. Whenever a row is inserted into the DateMarket database 604, inserted one or more DateMarketSegment database tables 608 will also be inserted. The DateMarketSegment database table 608 can be inserted for the market (travel route) and every segment in the travel route that comprises the low fare. A DateFlightLowFare database table 610 stores low fare amounts for each flight in a date market. The DateFlightLowFare database table 610 is a child of DateMarketLowFare database table 606 with an identifying relationship and a one-to-many cardinality.

FIG. 7 depicts an example process 700 for determining an available low fare for a travel route for a specific date. In some examples, the process 700 can be implemented using one or more computer program applications executed using one or more computing devices. For purposes of illustration, a non-limiting example context is provided that is directed to available low fares for flights. In some cases, a request can be made for a range of departure dates and multiple markets. The process 700 can be performed for each date and market in a request.

A request is received for a lowest available fare for a travel route on a specific date in step 702. For example, an availability service receives a request for lowest available fares for travel from Salt Lake City (SLC) to New York City's JFK international airport (JFK) during the month of June 2013. The availability service receives the request on Apr. 1, 2013. The process 700 can first receive a specific date of Jun. 1, 2013. It is determined if the low fare data is stored in a low fare cache in step 704. For example, the availability service reads the data in a low fare cache included in the availability service to determine if low fare data for a flight on Jun. 1, 2013 from SLC to JFK is stored in the low fare cache. If the low fare data for the flight is not stored in the low fare cache, the low fare data is requested from the core system in step 706. For example, the availability service can request that a core system obtain fares for travel on Jun. 1, 2013 from SLC to JFK from multiple travel conveyance providers and global distribution systems. The core system can calculate the lowest available fare for the specific date and travel route. In some cases, the core system may determine that there are no flights available for the travel route on the specific date. In other cases, the core system may determine that there are no available fares for the travel route on the specific date. The low fare data and/or the availability information about the low fare data is obtained from the core system in step 710. For example, the availability service receives the low fare data and the parameters used in the determination of the lowest fare. The low fare data and/or the availability information are stored in the low fare cache in step 712. For example, the availability service stores the pre-calculated low fare data and its associated parameters for the specific travel route and date received from the core system in the low fare cache. In another example, an indication that there are no flights or available fares for the travel route for the specific date can be stored in the low fare cache.

It is determined whether fares are available for the specific travel route and date in step 713. If a data entry in the low fare cache for the specific travel route and date includes an indication that there are no flights or available fares for the travel route for the specific date, it is determined if another date is requested in step 716. If a data entry in the low fare cache for the specific travel route and date does not include an indication that there are no flights or available fares for the travel route for the specific date, the low fare data is provided in response to the request in step 714 and it is determined if another date is requested in step 716.

For example, the core system calculates the lowest fare on Jun. 1, 2013 from SLC to JFK is $345. In addition, the fare is in two segments: SLC to Denver (DEN) and DEN to JFK, and the fare is valid until May 1, 2013. If it is determined in step 716 that another date is requested, the process 700 continues to step 702. In this example, the process 700 would continue to step 702 requesting the lowest available fare for travel from SLC to JFK on Jun. 2, 2013. The process 700 can be executed for all days in the month of June.

If in step 704 it is determined that the low fare data is stored in the cache, the validity of the low fare data is checked in step 718. If it is determined that the fare data is invalid, the process 700 continues to step 706 and requests the low fare data from the core system. For example, the low fare cache includes a low fare data entry for travel from SLC to JFK on Jun. 1, 2013 but the low fare data entry is marked as invalid. In this example, the low fare data for the SLC to JFK flight on Jun. 1, 2013 is for a flight consisting of two segments: an SLC to DEN flight and a DEN to JFK flight. It was previously determined that the fare for the SLC to DEN flight on Jun. 1, 2013 is no longer valid making the fare for the SLC to JFK flight on Jun. 1, 2013 also no longer valid.

If in step 718 it is determined that the low fare data entry is valid, it is determined if an availability period associated with the validity of the low fare data has expired in step 720. If it is determined that the availability period for the low fare data has expired, the process 700 continues to step 706 and requests the low fare data from the core system. For example, the low fare cache includes a low fare data entry for travel from SLC to JFK on Jun. 1, 2013 but a parameter associated with the low fare data entry indicates that the fare is valid during March 2013. The availability service determines that the current UTC date is Apr. 1, 2013 so the fare is no longer available, as its availability period has expired. In step 720, if it is determined that the availability period for the fare has not expired, the process continues to step 713 and, as described above, it is determined whether fares are available for the specific travel route and date.

The core system provides date and time expiration parameters associated with the low fare data provided to an availability service. The availability service can store the date and time expiration parameters with the low fare data as an entry in the low fare cache. The availability service can then use the date and time expiration parameters for the low fare data to determine if, at a particular point in time, the low fare data is valid. For example, if the availability service determines that the current UTC date and time is beyond that of the date and time expiration parameters associated with the low fare data entry in the low fare cache, the fare is expired and is no longer valid. The association of date and time expiration parameters with low fare data can support system, booking class, and fare restrictions for which no event messages (e.g., class of seats has sold out and are no longer available) from the low fare queue can be expected (e.g., low fare data related to the advanced purchase restrictions).

FIG. 8 depicts an example process 800 for receiving booking change events for storage in a queue. In some examples, the process 800 can be implemented using one or more computer program applications executed using one or more computing devices. For purposes of illustration, a non-limiting example context is provided that is directed to available low fares for flights.

An inventory change event is received in step 802. For example, referring to FIG. 3, the inventory AVS sink 310 receives information about an inventory change event (e.g., additional seats in travel class Y have been added to the flight from DEN to JFK on Jun. 1, 2013). An AVS message about the inventory change event is sent to a low fare queue in step 804. A fare change event is received in step 806. For example, referring to FIG. 3, the fare AVS sink 308 receives information about a fare change event (e.g., the seats in travel class X on the flight from SLC to DEN on Jun. 1, 2013 are discounted 25% until May 15, 2013). An AVS message about the fare change event is sent to a low fare queue in step 808. A commitment change event is received in step 810. For example, referring to FIG. 3, the commit AVS sink 312 receives information about a commitment change event (e.g., a passenger booked the last available seat in class Y on the flight from BOS to JFK on Jun. 15, 2013). An AVS message about the commitment change event is sent to an AVS queue in step 812.

If it is determined that the commitment change event affects the availability of a low fare in step 814, the AVS message about the commitment change event is sent to a low fare queue in step 816. For example, the LF listener 318 reads the message stored in the AVS queue 314 and sends it to the low fare queue 306 if the commitment change event affects low fare data. If it is determined that the commitment change event does not affect the availability of a low fare in step 814, the LF listener 318 filters out the message stored in the AVS queue 314 and the process 800 ends.

FIG. 9 depicts an example process 900 for reading a queue to determine if a queue entry invalidates a cache entry. In some examples, the process 900 can be implemented using one or more computer program applications executed using one or more computing devices. For purposes of illustration, a non-limiting example context is provided that is directed to available low fares for flights.

A low fare queue entry is read in step 902. For example, referring to FIG. 3, the AS listener 302c can read an entry from the low fare queue 306. As described above, the low fare queue entry can be a message indicating an inventory change event, a fare change event or an applicable commitment change event has occurred that may affect the reliability of one or more entries in the in-memory low fare cache 302b. The low fare queue entry is compared to a cache entry in step 904. For example, the low fare queue entry can be a message indicating that the low fare from SLC to DEN on Jun. 1, 2013 is no longer available. This information is then compared with the low fare data entry in the in-memory low fare cache 302b and its associated parameters. If it is determined that the low fare queue entry that was read affects the reliability of the cache entry in step 906, the cache entry is invalidated in step 910. If there are additional cache entries to be checked as determined in step 912, the process continues to step 904, otherwise the process 900 ends. For example, low fare data for the low fare travel route from SLC to DEN on Jun. 1, 2013 is stored in the in-memory low fare cache 302a. Since the low fare from SLC to DEN on Jun. 1, 2013 is no longer available, the low fare data entry for the travel route from SLC to DEN on Jun. 1, 2013 is no longer valid.

If it is determined that the low fare queue entry that was read does not affect the reliability of the cache entry in step 906, it is determined whether the low fare queue entry that was read affects the reliability of a dependency of the cache entry in step 908. If it is determined that the low fare queue entry that was read affects the reliability of a dependency of the cache entry in step 908, the cache entry is invalidated in step 910. If there are additional cache entries to be checked as determined in step 912, the process continues to step 904, otherwise the process 900 ends. For example, low fare data for a low fare travel route from SLC to JFK on Jun. 1, 2013 is stored in the in-memory low fare cache 302a. Dependency parameters associated with the low fare data indicate the travel route from SLC to JFK on Jun. 1, 2013 is comprised of two segments: SLC to DEN and DEN to JFK. Since the low fare from SLC to DEN on Jun. 1, 2013 is no longer available, and SLC to DEN is a segment of the SLC to JFK travel route, the low fare data entry for the travel route from SLC to JFK on Jun. 1, 2013 is no longer valid.

In some implementations, a travel options caching system can provide lowest cost travel accommodation class data. In this implementation, a request may be for a specific travel accommodation on a range of travel dates. The travel options caching system can perform in a manner similar to the systems described in FIGS. 3 and 4 to determine the lowest cost travel accommodation class data over the range of travel dates.

Although the examples described throughout this disclosure largely relate to fares for airline travel, the techniques described may be applied to other types of travel options for airline travel and may be applied outside of the airline reservations industry. For example, the described techniques may be applied to car rental reservations, hotel reservations, train and bus reservations, retail reservations, such as movies, theater shows, restaurant reservations, etc., and/or other types of services that users book in advance and have variable rates depending on the date booked.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations and all of the functional operations described in this specification may be realized in digital electronic circuitry, or in computer software, firmware, or hardware, including the structures disclosed in this specification and their structural equivalents, or in combinations of one or more of them. Implementations may be provided using one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be provided on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be provided in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be provided in combination in a single implementation. Conversely, various features that are described in the context of a single implementation may also be provided in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method using one or more processors, the method comprising:
receiving a first request for lowest available fare data including a lowest available fare for a particular travel route for a specific date;
responsive to the first request, determining that data for the lowest available fare for the particular travel route for the specific date is not included in a cache;
based on determining that the data for the lowest available fare for the particular travel route for the specific date is not included in the cache, providing, to a core system, a request for the data for the lowest available fare for the particular travel route for the specific date;
receiving, from the core system, the data for the lowest available fare for the particular travel route for the specific date;
storing, in the cache, the received data for the lowest available fare for the particular travel route for the specific date;
responding to the first request based on the data received from the core system for the lowest available fare for the particular travel route for the specific date;
after storing, in the cache, the received data for the lowest available fare for the particular travel route for the specific date, receiving a second request for lowest available fare data including the lowest available fare for the particular travel route for the specific date;
responsive to the second request, determining that the data for the lowest available fare for the particular travel route for the specific date is included in the cache;
based on determining that the data for the lowest available fare for the particular travel route for the specific date is included in the cache, accessing, from the cache, the data for the lowest available fare for the particular travel route for the specific date; and
responding to the second request based on the data accessed from the cache for the lowest available fare for the particular travel route for the specific date.

2. The method of claim 1, wherein:
the travel route is comprised of one or more segments, and
the method further comprises:
accessing a queue;
determining that the queue includes an entry associated with a segment of the particular travel route for the specific date;
determining that the entry impacts reliability of the data for the lowest available fare for the particular travel route for the specific date; and
based on determining that the entry impacts reliability of the data for the lowest available fare for the particular travel route for the specific date, deleting, from the cache, the data for the lowest available fare for the particular travel route for the specific date.

3. The method of claim 2, wherein determining that the entry impacts reliability of the data for the lowest available fare for the particular travel route for the specific date comprises:
determining that travel accommodations in a fare class for the segment of the particular travel route are no longer available.

4. The method of claim 2, wherein determining that the entry impacts reliability of the data for the lowest available fare for the particular travel route for the specific date comprises:
determining that a specified time frame for availability of the segment of the particular travel route has expired.

5. The method of claim 2, wherein determining that the entry impacts reliability of the data for the lowest available fare for the particular travel route for the specific date comprises:
determining that travel accommodations for the segment of the particular travel route are not available.

6. The method of claim 2, further comprising storing an entry in the queue based on a change in inventory for a travel conveyance providing accommodations for one or more components of a travel route.

7. The method of claim 2, further comprising storing an entry in the queue based on a change in the available fare for one or more segments of a travel route.

8. The method of claim 2, further comprising storing an entry in the queue based on determining that a change in commitment affects the availability of a fare for one or more segments of a travel route.

9. The method of claim 1, further comprising:
deleting, from the cache, one or more entries based on one or more rules for deleting a cache entry.

10. The method of claim 9, wherein the one or more rules include a rule that specifies deleting cache entries based on a time frame.

11. The method of claim 1, further comprising:
receiving an additional request for a lowest available fare for the particular travel route for one or more dates other than the specific date;
responsive to receiving the additional request, determining, for each of the one or more dates, whether data for the lowest available fare for the particular travel route is included in the cache;
providing, to a core system, a request for the data for the lowest available fare for the particular travel route for each of the one or more dates whose data for the lowest available fare for the particular travel route is not included in the cache;
receiving, from the core system, the data for the lowest available fare for the particular travel route for each of the one or more dates whose data for the lowest available fare for the particular travel route is not included in the cache;
storing, in the cache, the received data for the lowest available fare for the particular travel route for each of the one or more dates; and
responding to the additional request based on the data accessed from the cache for the lowest available fare for the particular travel route for each of the one or more dates other than the specific date.

12. The method of claim 11, wherein the one or more dates other than the specified date are during a certain time period relative to the specific date.

13. The method of claim 1, wherein an availability service:
receives the first request for a lowest available fare data for a particular travel route for a specific date,
determines that the lowest available fare for the particular travel route for the specific date is not included in a cache, and
interfaces with the core system to request and receive the data for the lowest available fare for the particular travel route for the specific date.

14. The method of claim 13, wherein:
the availability service is one of a plurality of availability services, and a selection of an availability service to receive the first request is based on one or more load factors associated with each of the plurality of availability services.

15. The method of claim 1, further comprising:
storing an indication that the data for the lowest available fare for the particular travel route for the specific date was not included in the cache.

16. The method of claim 1, wherein the data for the lowest available fare for the particular travel route for the specific date stored in the cache is different from the data for the lowest available fare for the particular travel route for the specific date when booking a travel accommodation for the particular travel route for the specific date.

17. The method of claim 17, further comprising recording occurrences of the lowest available fare for the particular travel route for the specific date stored in the cache being different from the lowest available fare for the particular travel route for the specific date when booking a travel accommodation for the particular travel route for the specific date.

18. The method of claim 1, wherein responding to the second request based on the data accessed from the cache for the lowest available fare for the particular travel route for the specific date comprises responding with no interaction with the core system.

19. A system comprising:
one or more computers; and
a computer-readable medium coupled to the one or more computers having instructions stored thereon which, when executed by the one or more computers, cause the one or more computers to perform operations comprising:
receiving a first request for lowest available fare data including a lowest available fare for a particular travel route for a specific date;
responsive to the first request, determining that data for the lowest available fare for the particular travel route for the specific date is not included in a cache;
based on determining that the data for the lowest available fare for the particular travel route for the specific date is not included in the cache, providing, to a core system, a request for the data for the lowest available fare for the particular travel route for the specific date;
receiving, from the core system, the data for the lowest available fare for the particular travel route for the specific date;
storing, in the cache, the received data for the lowest available fare for the particular travel route for the specific date;
responding to the first request based on the data received from the core system for the lowest available fare for the particular travel route for the specific date;
after storing, in the cache, the received data for the lowest available fare for the particular travel route for the specific date, receiving a second request for lowest available fare data including the lowest available fare for the particular travel route for the specific date;
responsive to the second request, determining that the data for the lowest available fare for the particular travel route for the specific date is included in the cache;
based on determining that the data for the lowest available fare for the particular travel route for the specific date is included in the cache, accessing, from the cache, the data for the lowest available fare for the particular travel route for the specific date; and
responding to the second request based on the data accessed from the cache for the lowest available fare for the particular travel route for the specific date.

20. A computer storage medium encoded with a computer program, the computer program comprising instructions that when executed by one or more processors cause the one or more processors to perform operations comprising:
receiving a first request for lowest available fare data including a lowest available fare for a particular travel route for a specific date;
responsive to the first request, determining that data for the lowest available fare for the particular travel route for the specific date is not included in a cache;
based on determining that the data for the lowest available fare for the particular travel route for the specific date is not included in the cache, providing, to a core system, a request for the data for the lowest available fare for the particular travel route for the specific date;
receiving, from the core system, the data for the lowest available fare for the particular travel route for the specific date;
storing, in the cache, the received data for the lowest available fare for the particular travel route for the specific date;
responding to the first request based on the data received from the core system for the lowest available fare for the particular travel route for the specific date;
after storing, in the cache, the received data for the lowest available fare for the particular travel route for the specific date, receiving a second request for lowest available fare data including the lowest available fare for the particular travel route for the specific date;
responsive to the second request, determining that the data for the lowest available fare for the particular travel route for the specific date is included in the cache;
based on determining that the data for the lowest available fare for the particular travel route for the specific date is included in the cache, accessing, from the cache, the data for the lowest available fare for the particular travel route for the specific date; and
responding to the second request based on the data accessed from the cache for the lowest available fare for the particular travel route for the specific date.
